(19) United States
(12) Patent Application Publication
(10) Pub. No.: US 2025/0141166 A1
(43) Pub. Date: May 1, 2025

(54) THREADLESS F-PORT CONNECTOR

(71) Applicant: Amphenol Cabelcon ApS, Vordingborg (DK)

(72) Inventor: Søren Baldus-Kunze, Slagelse (DK)

(21) Appl. No.: 18/699,391

(22) PCT Filed: Oct. 7, 2022
(86) PCT No.: PCT/IB2022/059582

§ 371 Date: Apr. 8, 2024

Related U.S. Application Data
(60) Provisional application No. 63/262,275, filed on Oct. 8, 2021.
(60) Provisional application No. 63/306,789, filed on Feb. 4, 2022.

(51) Int. Cl. H01R 24/40; H01R 13/631; H01R 43/26; H01R 103/00

(52) U.S. Cl. CPC H01R 24/40; H01R 13/631; H01R 43/26; H01R 2103/00

(57) ABSTRACT

A mating port has a threadless body with a leading body portion, a rear body portion, and an intermediate body portion between the leading body portion and the rear body portion. The intermediate body portion has an outer surface with an outer surface diameter. A reduced body portion is located at the intermediate body portion of the body, with a reduced body portion diameter smaller than the outer surface diameter. A leading ramp is located at the leading body portion of the body, projecting outward with respect to the reduced body portion at the intermediate body portion to define a leading ramp diameter larger than the reduced body portion diameter. The leading ramp, outer surface of said intermediate body portion, and reduced body portion define an outer contour of the threadless body, the outer contour configured to engage a displacement member under tension of a mating connector.

### RELATED APPLICATION

This application claims the benefit of priority of U.S. Provisional Application No. 63/262,275, filed on Oct. 8, 2021, the content of which is relied upon and incorporated herein by reference in its entirety.

### BACKGROUND

The present disclosure generally relates to coaxial connectors, such as F-Type connectors, and particularly F-Type female or mating ports having one or more engagement features, such as snap-in features that facilitate connection to a mating male connector element.

F-Type ports are components of F-Type connectors, which are defined by applicable standards and are commonly used in the “drop” end of a network installation with high frequency signals. In general terms, the male connector has the inner conductor exposed or connected via a captive pin. The female connector has a central socket that receives the pin of the male connector. Conventional F-Type female connectors have external threading and the male connector has a nut that is internally threaded to threadably engage the external threading of the female connector. While threaded designs offer many advantages, these designs can cause complications, such as threads becoming broken, or the threads not being matched correctly with mated components, etc. One example of an F-Type connector is shown in WO2020/205402, which is herein incorporated by reference in its entirety. No admission is made that any reference cited herein constitutes prior art. Applicant expressly reserves the right to challenge the accuracy and pertinence of any cited documents.

### SUMMARY

In a first example embodiment, a mating port has a threadless body with a leading body portion, a rear body portion, and an intermediate body portion between the leading body portion and the rear body portion. The intermediate body portion has an outer surface with an outer surface diameter. A reduced body portion is located at the intermediate body portion of the body, with a reduced body portion diameter smaller than the outer surface diameter. A leading ramp is located at the leading body portion of the body, projecting outward with respect to the reduced body portion at the intermediate body portion to define a leading ramp diameter larger than the reduced body portion diameter. The leading ramp, outer surface of said intermediate body portion, and reduced body portion define an outer contour of the threadless body, the outer contour configured to engage a displacement member under tension of a mating connector.

A second example embodiment includes the mating port of the first embodiment, wherein the mating port is a female port. A third example embodiment includes the mating port of the first or second embodiment, wherein the mating port is an F-type port. A fourth example embodiment includes the mating port of any of the first through third embodiments, wherein the reduced body portion has one or more annular grooves positioned in the outer surface of said intermediate body portion directly behind said leading ramp. A fifth example embodiment includes the mating port of any of the first through fourth embodiments, wherein the outer contour of the threadless body has a shape that cooperates with the displacement member as the mating connector is slidably engaged with the mating port.

A sixth example embodiment includes the mating port of any of the first through fifth embodiments, wherein the threadless body has a leading interface surface, whereby the leading ramp cooperates with the displacement member to apply a forward insertion pressure that engages the leading interface surface with a mating interface surface of a male connector.

A seventh example embodiment includes the mating port of any of the first through sixth embodiments, further including a rear ramp at the rear body portion of the body, the rear ramp projecting outward with respect to the outer surface of the intermediate body portion. An eighth example embodiment includes the mating port of the seventh embodiment, wherein the rear ramp cooperates with the displacement member to apply a pressure that provides a radio frequency seal between the female port and the mating male connector. A ninth example embodiment includes the mating port of the seventh or eighth embodiments, wherein the rear ramp aligns with a front support member of the mating connector. A tenth example embodiment includes the mating port of the ninth embodiment, further including a gap between the rear ramp and the front support member. An eleventh example embodiment includes the mating port of any of the first through tenth embodiments, wherein the displacement member is a spring. A twelfth example embodiment includes the mating port of any of the first through eleventh embodiments, further having an angled surface at a trailing side of the leading ramp, the angled surface configured to engage the displacement member under tension.

A thirteenth example embodiment is a mating port having a threadless body with a leading body portion, a rear body portion, and an intermediate body portion between the leading body portion and the rear body portion. The intermediate body portion has an outer surface with an outer surface diameter. The mating port further has a leading ramp at the leading body portion of the body. The leading ramp projects outward with respect to the intermediate body portion to define a leading ramp diameter larger than the outer surface diameter. The leading ramp and the outer surface of the intermediate body portion define an outer contour of the threadless body. The outer contour is configured to engage a displacement member under tension of a mating connector.

A fourteenth example embodiment is a mating port having a threadless body with an outer contour. The body has a leading body portion, a rear body portion, and an intermediate body portion between the leading body portion and the rear body portion. The intermediate body portion has an outer surface. The threadless body further has a reduced portion with a reduced portion diameter. An annular rear ramp is located at the rear portion of the body. The rear ramp projects outward with respect to the outer surface of the intermediate body portion and is configured to engage a displacement member under tension of a mating male connector.

A fifteenth example embodiment includes the mating port of the fourteenth embodiment, wherein the outer contour of said threadless body is smooth.

A sixteenth example embodiment includes the mating port of the fourteenth or fifteenth embodiments, further including a leading ramp at the leading body portion of the body, the leading ramp projecting outward with respect to the outer surface of the intermediate body portion and configured to engage the displacement member under tension of the mating male connector. A seventeenth example embodiment includes the mating port of the sixteenth embodiment, wherein the threadless body has a leading interface surface, whereby the leading ramp cooperates with the displacement member to apply a forward insertion pressure that engages the leading interface surface with a mating interface surface of a male connector.

An eighteenth example embodiment includes the mating port of the sixteenth or seventeenth embodiments, further including one or more grooves positioned in the outer surface of the intermediate body portion directly behind the leading ramp.

A nineteenth example embodiment includes the mating port of any of the sixteenth through eighteenth embodiments, further including an angled surface at a trailing side of the leading ramp, the angled surface configured to engage the displacement member under tension. A twentieth example embodiment includes the mating port of any of the fourteenth through nineteenth embodiments, wherein the rear ramp cooperates with the displacement member to apply a pressure that provides a radio frequency seal between the female port and the mating male connector. A twenty-first example embodiment includes the mating port of any of the fourteenth through twentieth embodiments, wherein the displacement member is a spring.

A twenty-second example embodiment is a method for engaging a mating port having a threadless body with a leading body portion and an intermediate body portion, and a displacement member of a male connector. The method includes providing the mating port with an annular leading ramp at the leading body portion projecting outward from the intermediate body portion; providing one or more grooves at the intermediate body portion, wherein the leading ramp and the one or more grooves define an outer contour of the threadless body; and engaging the outer contour of the threadless body with the displacement member under tension.

A twenty-third example embodiment is a mating port having a threadless body with an outer contour, the body having a leading body portion, a rear body portion, and an intermediate body portion between the leading body portion and the rear body portion, the intermediate body portion having an outer surface. An annular outer shoulder and/or annular groove is provided at the intermediate body portion of the body, the annular outer shoulder projecting outward with respect to the outer surface of the intermediate body portion and the groove recessed with respect to the outer surface of the intermediate body portion. The outer shoulder and/or groove are configured to engage a displacement member under tension of a mating male connector.

A twenty-fourth example embodiment is a female port having a body with an outer contour. The body has a leading body portion, a rear body portion, and an intermediate body portion between the leading body portion and the rear body portion, the intermediate body portion having an outer surface. A leading ramp is provided at the leading body portion of the body, the leading ramp projecting outward with respect to the outer surface of the intermediate body portion and configured to engage a displacement member under tension of a mating male connector.

A twenty-fifth example embodiment includes the female port of the twenty-fourth embodiment, further including a rear ramp at the rear body portion of the body, the rear ramp projecting outward with respect to the outer surface of the intermediate body portion and configured to engage the displacement member under tension of the mating male connector. A twenty-sixth example embodiment includes the female port of the twenty-fourth or twenty-fifth embodiments, wherein the body has a leading interface surface, whereby the leading ramp cooperates with the displacement member to apply a forward insertion pressure that engages the leading interface surface with a mating interface surface of a male connector. A twenty-seventh example embodiment includes the female port of any of the twenty-fourth through twenty-sixth embodiments, wherein the rear ramp cooperates with the displacement member to apply a pressure that provides an RF seal between the female port and the mating male connector.

A twenty-eighth example embodiment includes the female port of any of the twenty-fourth through twenty-seventh embodiments, wherein the displacement member is a spring. A twenty-ninth example embodiment includes the female port of any of the twenty-fourth through twenty-eighth embodiments, further having a groove positioned in the outer surface of the intermediate body portion directly behind the leading ramp. A thirtieth example embodiment includes the female port of any of the twenty-fourth through twenty-ninth embodiments, further having an angled surface at a trailing side of the leading ramp, the angled surface configured to engage the displacement member under tension.

A thirty-first example embodiment is female port having a body with an outer contour, the body having a leading body portion, a rear body portion, and an intermediate body portion between the leading body portion and the rear body portion, the intermediate body portion also having an outer surface. A rear ramp is at the rear portion of the body, the rear ramp projecting outward with respect to the outer surface of the intermediate body portion and configured to engage a displacement member under tension of a mating male connector.

A thirty-second example embodiment includes the female port of the thirty-first embodiment, further including a leading ramp at the leading body portion of the body, the leading ramp projecting outward with respect to the outer surface of the intermediate body portion and configured to engage the displacement member under tension of the mating male connector. A thirty-third example embodiment includes the female port of the thirty-first or thirty-second embodiments, wherein the body has a leading interface surface, whereby the leading ramp cooperates with the displacement member to apply a forward insertion pressure that engages the leading interface surface with a mating interface surface of a male connector.

A thirty-fourth example embodiment includes the female port of any of the thirty-first through thirty-third embodiments, wherein the rear ramp cooperates with the displacement member to apply a pressure that provides an RF seal between said female port and the mating male connector. A thirty-fifth example embodiment includes the female port of any of the thirty-first through thirty-fourth embodiments, wherein the displacement member comprises a spring. A thirty-seventh example embodiment includes the female port of any of the thirty-first through thirty-sixth embodiments, further including a groove positioned in the outer surface of the intermediate body portion directly behind the leading ramp. A thirty-eighth example embodiment includes the female port of any of the thirty-first through thirty-seventh embodiments, further having an angled surface at a trailing side of said leading ramp, the angled surface configured to engage the displacement member under tension.

This summary is not intended to identify all essential features of the claimed subject matter, nor is it intended for use in determining the scope of the claimed subject matter. It is to be understood that both the foregoing general description and the following detailed description are exemplary and are intended to provide an overview or framework to understand the nature and character of the disclosure.

### BRIEF DESCRIPTION OF THE FIGURES

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIG. 1 is a cross-sectional view of an F-type connector assembly having a male connector, displacement member and female port in accordance with one example of the present disclosure;

FIG. 2 is a cross-sectional view of another example of an F-type connector assembly;

FIGS. 3A-3L show examples of the displacement member;

FIGS. 4A-4L show cross-sectional views of the displacement members of FIGS. 3A-3L, respectively;

FIGS. 5A-5D show one example of a male connector slidably engaging a female port;

FIGS. 6A-6R show examples of a mating port in accordance with the present disclosure;

FIG. 7A shows one example displacement member;

FIG. 7B shows one example mating port configured to mate with and engage the displacement member of FIG. 7A;

FIGS. 8A-8D show the mating port of FIG. 7B slidably engaging a male connector having a displacement member of FIG. 7A;

FIGS. 9A, 9B are images of a displacement member of FIGS. 3A, 3G, respectively, under tension;

FIGS. 10A, 10B show the mating port having a plastic ring; and

FIGS. 11-13 show the RF leakage as a function of the pressures.

### DETAILED DESCRIPTION

In describing the illustrative, non-limiting embodiments illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several embodiments are described for illustrative purposes, it being understood that the description and claims are not limited to the illustrated embodiments and other embodiments not specifically shown in the drawings may also be within the scope of this disclosure.

It is one feature of the disclosure to provide a quick-connect connector, such as for example, without limitation, push-on connectors and spring connect connectors. It is a further feature to provide a quick-connect connector that has optimum and reliable performance, such as for example, without limitation, a reliable electrical and/or mechanical connection. It is another feature to provide a quick-connect connector that has optimum and reliable performance over time and with repeated on and off use. It is a further feature to provide a quick-connect connector for standard F-ports. It is a further feature to provide a quick-connect connector that minimizes RF leakage. It is still a further feature to provide a quick-connect connector having an easy on/hard off and/or an audible click when in a locked position.

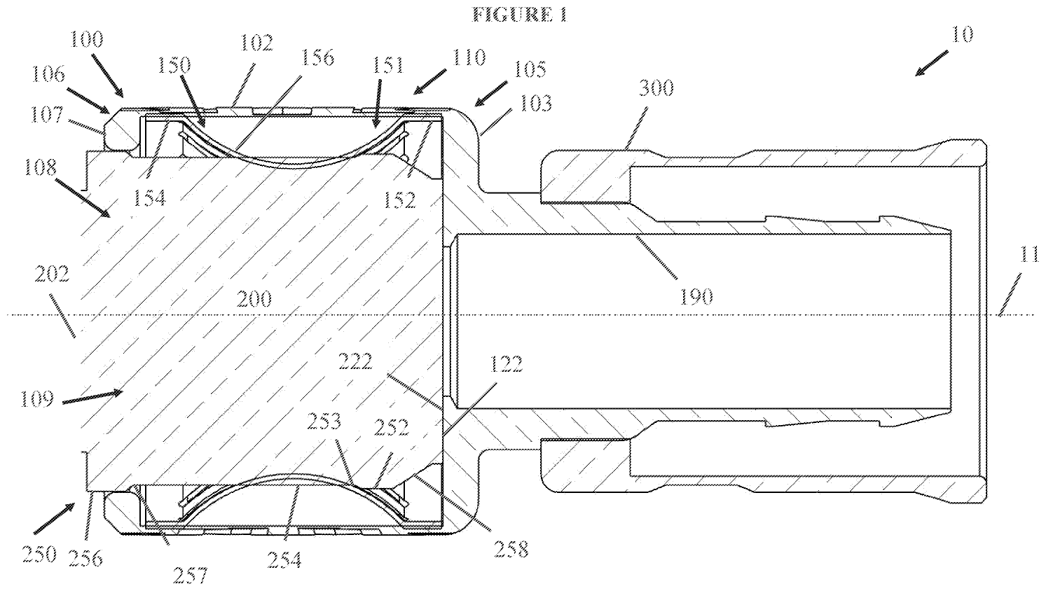

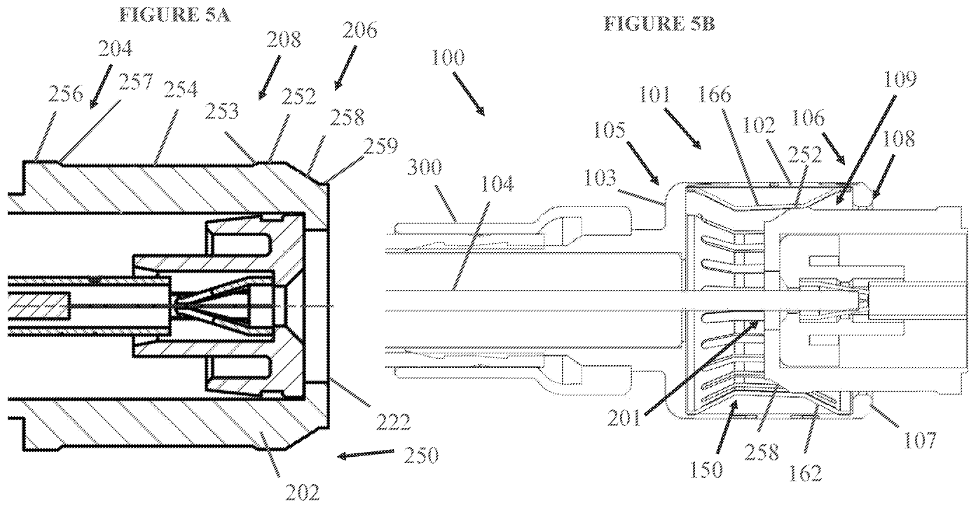

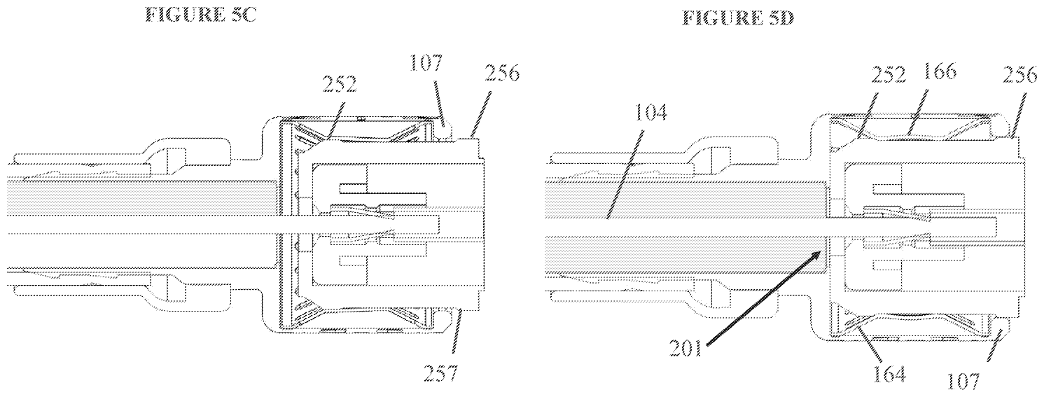

Turning to the drawings, FIGS. 1 and 5B show a connector assembly 10 in accordance with one illustrative, non-limiting embodiment of the disclosure. The connector 10 includes a coaxial connector, such as an F-type male connector 100, an female or mating barrel or port 200, and a cable fastener 300, such as an adapter, connector, or the like, here shown as a crimp-type fastener or connector 300. The male connector 100 has a leading receiving portion 101 and a captive center pin 104. The male connector 100 terminates a cable to form the inner conductor which is exposed or connected via a captive pin 104. The mating port 200, here shown as a female port 200, has a central opening or socket 201 that receives the pin 104 of the male connector 100.

The receiving portion 101 is shown here as a connector housing 110. In the non-limiting example embodiment shown, the connector housing 110 has a circular side wall or an annular wall 102 with a distal end 105 and a proximal end 106. The distal end 105 has a rear support member 103 that extends inward from the annular wall 102 and couples to a rear elongated member 190, e.g., a post. The proximal end 106 has an inwardly extending front support member 107 that forms a central opening 108 (FIG. 5B) in the proximal end 106.

Accordingly, the annular wall 102 extends substantially parallel or concentric with a longitudinal axis 11 of the connector 10 and the male connector 100, such that a longitudinal cross-section of the wall 102 is substantially parallel to the longitudinal axis. In addition, the rear and front support members 103, 107 are substantially perpendicular to the wall 102 and the longitudinal axis. The receiving portion 101 of the male connector 100 slidably receives the female or mating port 200 into the receiving area 109 through the opening 108, so that the pin 104 is slidably received in the socket 201. The rear elongated member 190 can be formed around the cable and in some embodiments can be received, for example, in a central opening of the adapter 300, e.g., a cable fastener.

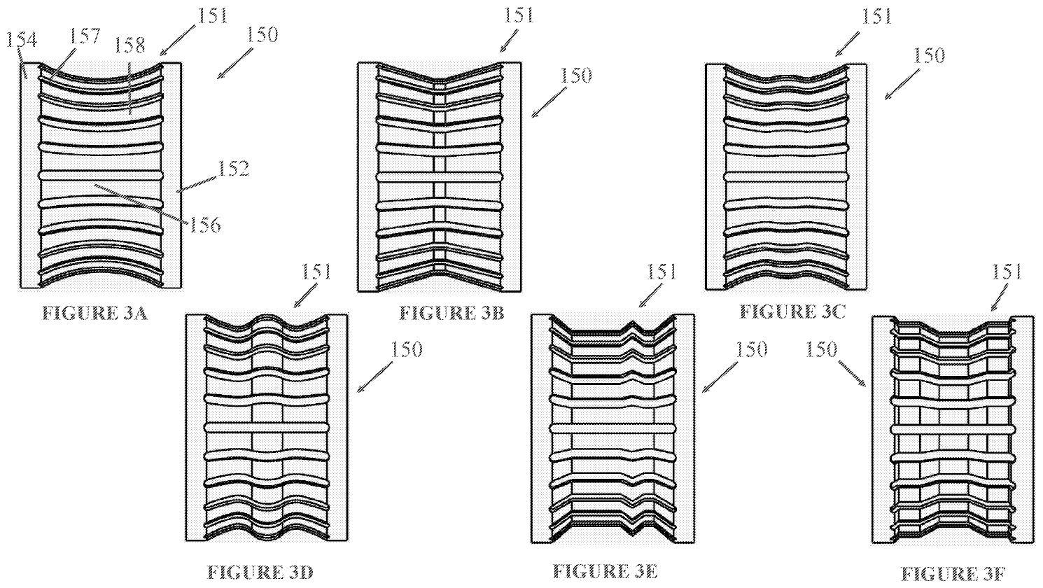

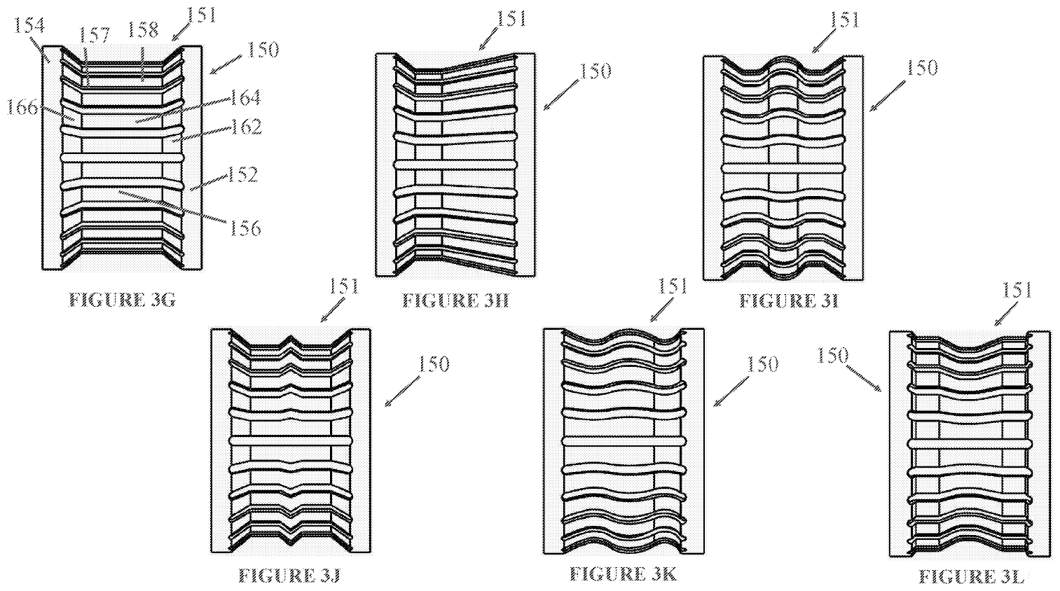

Still referring to FIGS. 1 and 5B, the receiving portion 101 of the male connector 100 encloses the exposed pin 104 and forms an interior receiving area 109 with the pin 104 inside the receiving area 109. A displacement member 150 is provided at the interior receiving area 109 of the receiving portion 101. The displacement member 150 can be a contact member to provide a ground contact. In the example embodiments shown, the displacement member 150 can have a spring force. In addition, the displacement member 150 can have a ring shape with a circular transverse cross-section. Referring to FIGS. 1 and 3A, the displacement member 150 has a first leading end 152, a second rear end 154 opposite the first end 152, and an intermediate portion 156 between the first and second ends 152, 154. The first and second ends 152, 154 each form a ring having a flat or linear cross-section, which in some embodiments can be substantially parallel or concentric with the longitudinal axis 11 and the wall 102 of the connector 100. The displacement member 150 is conductive, such as metal, to provide a ground connection with the mating port 200.

The intermediate portion 156 can be formed by one or more elongated strips 158 arranged parallel to one another with elongated slots 157 therebetween. The strips 158 extend from the first end 152 to the second end 154. In some embodiments, the intermediate portion 156 is integrally formed with the first and second ends 152, 154 to provide a single contiguous piece. The displacement member 150 is sized so that it is retained against the wall 102 of the receiving portion 101, and the ends 152, 154 of the displacement member 150 are retained between the front support 107 and the rear support 103, whereby the front and rear supports 107, 103 limit the outward motion of the ends 152, 154 as the intermediate portion 156 is compressed. The displacement member 150 is sufficiently rigid so that the intermediate portion 156 forms a spring with a springlike force that is biased outwardly with respect to the first and second ends 152, 156 and inwardly with respect to the center of the rear receiving portion 110 of the male connector 100.

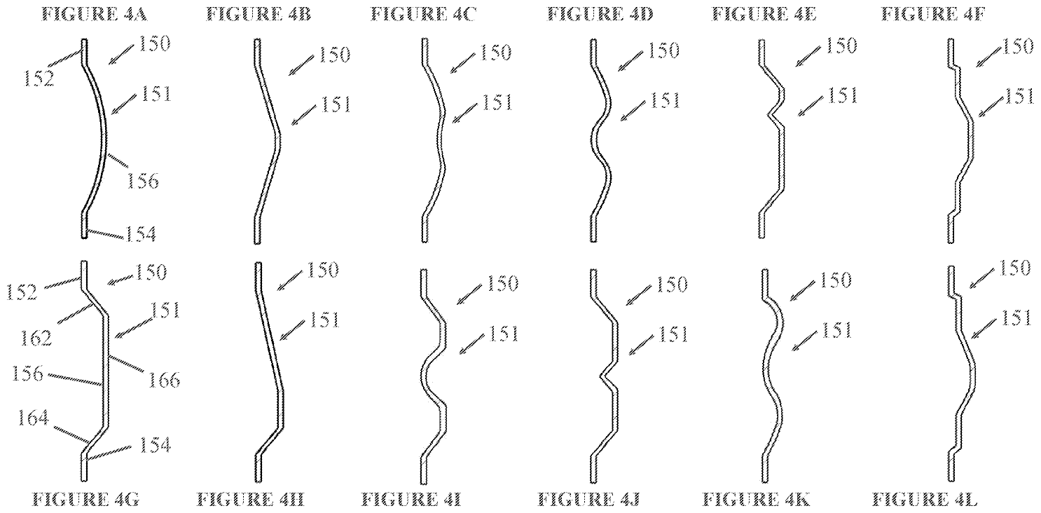

The displacement member 150 can have a variety of different contours 151 (i.e., shape, size, and relative dimensions), each configured to engage the mating port 200 under tension. For instance, FIGS. 1, 3A, 4A show a non-limiting example embodiment of a spring contour 151 design for the displacement member 150. FIG. 4A shows a cross-section of the displacement member, whereby the ends 152, 154 are flat and the intermediate portion 156 is curved inward toward the center of the receiving area 109 of the male connector 100, and the intermediate portion 156 has a cross-section that is a smooth uniform curve.

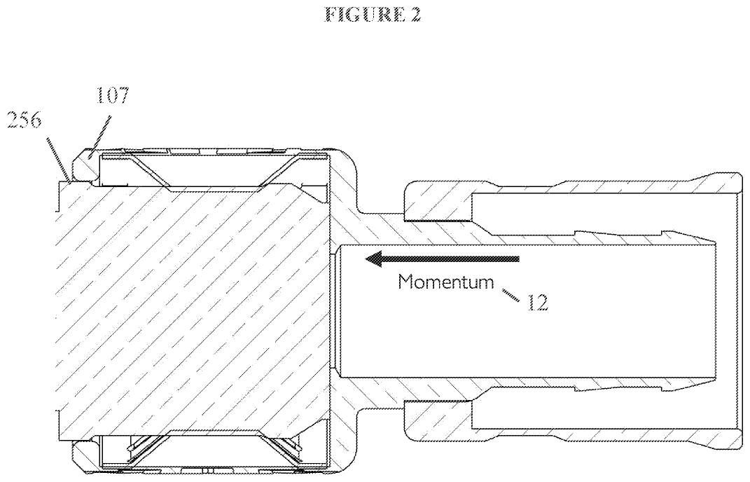

FIGS. 2, 3G, 4G show another non-limiting example embodiment of a spring contour 151 design for the displacement member 150. Here, the intermediate portion 156 has a cross-section that forms a front straight angled side portion 162, a rear straight angled side portion 164, and a central straight portion 166. The displacement member 150 is illustrated in FIGS. 1, 2 as extending past the surface of the female port for illustrative purposes only, namely to show that the inner diameter of the displacement member 150 (i.e., the spring) is smaller than the outer diameter of the female port 200 to enable the spring to tension on the contour of the female port 200.

Turning now to the non-limiting example embodiment of FIGS. 1, 2, 5, 6, the female or mating port 200 can have a single piece unitary body 202 with an outer surface or contour 250. In an example, the outer contour surface 250 is threadless, i.e., devoid of threads. In one example, the entire outer contour surface 250 can be threadless, though in other examples only a portion of the outer surface 250 that mates with the displacement member 150 is threadless. The body 202 includes a rear or trailing end body portion 204, a forward or leading end body portion 206 with a leading surface forming an interface 222, and an intermediate body portion 208 between the rear body portion 204 and the leading body portion 206.

The intermediate body portion 208 includes a flat outer surface 254, the rear body portion 204 includes a rear radio frequency (RF) seal ramp 256 that projects outward from the flat surface 254 to form a lip 257 therebetween. The rear ramp 256 has a flat top surface that is substantially parallel to the flat surface 254 and the longitudinal axis of the connector 10. The leading body portion 206 includes a front ramp 252 that projects outward from the flat surface 254 to form a lip 253, 257 therebetween. The front ramp 252 has a flat top surface that is substantially parallel to the flat surface 254 and the longitudinal axis of the connector 10. The lips 253, 257 can be orthogonal to the ramps 252, 256, respectively, or sloped at an obtuse angle to the ramp 252, 256, respectively, with respect to the flat surface 254.

In the example embodiment shown, the front and rear ramps 252, 256 can have the same outer diameter (i.e., formed by the respective lips 253, 257), so that the top surfaces of the front and rear ramps 252, 256 are aligned (i.e., substantially linear) with one another; though in other example embodiments the front and rear ramps 252, 256 can have different diameters so that the top surfaces are offset from one another. In addition, in the example embodiments of FIGS. 5A-5D, the intermediate portion 208 has an outer surface 254 with an outer surface diameter that is smaller than the outer leading ramp diameter of the leading ramp 252 and/or the rear ramp 256. Here, at least the intermediate portion outer surface 254 and the leading ramp 252 define an outer contour 250 of the body 202 which engages the displacement member 150 under tension when the male connector is slidably engaged with the mating port 200.

As further illustrated, the displacement member 150 is sufficiently flexible to have two operating modes: an activated mode and a relaxed mode. The displacement member 150 is in the relaxed mode when the port 200 is disconnected from the male connector 100. In the relaxed mode, the intermediate portion 156 is biased in the outward position (i.e., toward the center of the connector), as shown in FIGS. 1-4, 7A. The displacement member 150 enters the activated mode when the port 200 is received at the interior receiving area 109 of the rear receiving portion 101 of the male connector 100. In the activated mode, the displacement member 150 engages the outer surface of the female port. Once installed on the port, the displacement member 150 is in constant activated mode. Thus, the contour of the displacement member 150 in the activated mode, is not the same as in the relaxed mode. The contour of the displacement member 150 and/or the body 202 of the female port can be adjusted to fit the specific application. In some non-limiting example embodiments, the inner parts of the female port are standard as in a normal F81 barrel.

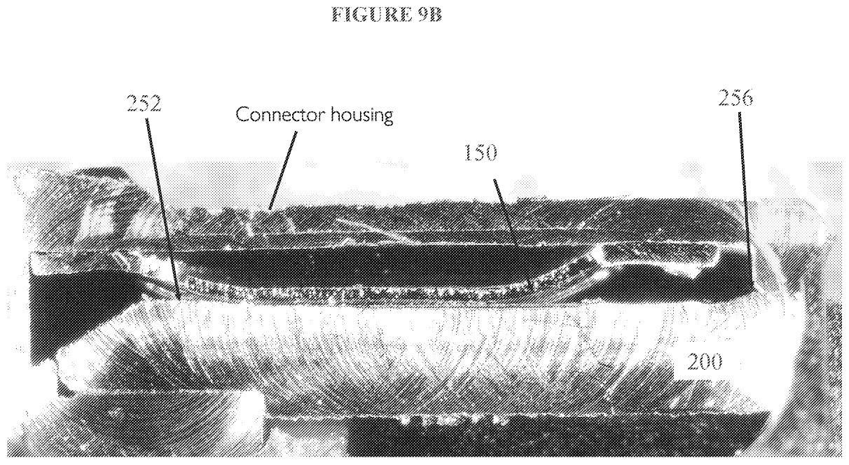

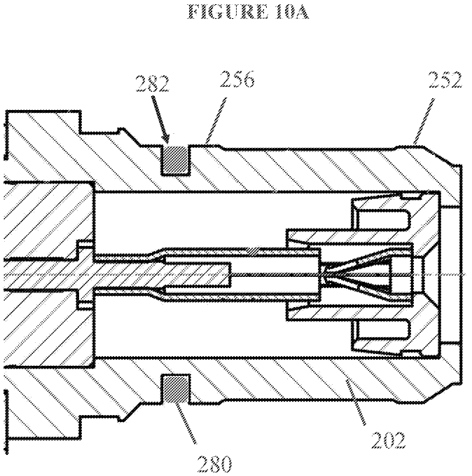

The activated mode of the displacement member 150 is best shown in FIGS. 5D, 8D, 9A, 9B. Turning first to FIG. 9A, a displacement member 150 corresponding to the one in FIGS. 1, 3A, 4A is shown. And in FIG. 9B, a displacement member 150 corresponding to the one shown in FIGS. 2, 3G, 4G is shown. In each embodiment, the displacement member 150 is compressed outwardly and flattened by contact with the outer contour 250 of the female port 200 in the activated mode (compare FIGS. 1, 3A, 4A to FIG. 9A; and compare FIGS. 2, 3G, 4G to FIG. 9B), which in turn increases the surface contact between the displacement member and the female port 200 (both of which are conductive material, such as metal). The front ramp 252 operates as an activation step and retainer, and the rear ramp 256 acts as an RF seal and rear spring support. Thus, in the activated state, the displacement member 150 remains compressed to exert a constant force against the female port contour 250 of the body 202.

The forward ramp 252 has an aft or rear surface that forms the lip 253, and a forward mating surface 258 that is sloped or angled so that the forwardmost end of the female port 200 is smaller and tapers outward to the forward ramp 252. An end cover 259 or a staking of the end can be provided that extends straight outward from the angled forward mating surface 258, though other shapes can be provided (e.g., the cover 259 can be beveled). As the isolator is sometimes installed from this side, a pressfit cover holds the parts in place. The shape may vary, but usually is flat as per the drawing.

Turning to FIGS. 5B-5D, the insertion process is shown, whereby the displacement member 150 moves from the relaxed mode (FIG. 5B) to the activated mode (FIG. 5D). Starting with FIG. 5B, the male connector 100 (with the spring displacement member 150) is inserted over the port 200, such that the forward tapered surface 258 of the ramp 252 of the port 200 engages the forward angled surface 162 of the displacement member 250 of the connector 100 to compress the spring 150. Referring to FIGS. 5B and 5C, the central straight portion 166 of the spring 150 then slides along the outer surface of the ramp 252, then down and past the lip 253. At that point (FIG. 5D), the rear angled portion 162 passes the forward ramp 252 and the port 200 is fully inserted into the receiving portion 101 of the male connector 100, making an audible snapping sound when the spring displacement member 150 expands outward and strikes the outer surface 254 of the body 202.

As further shown in FIG. 5D, the pin 104 is fully received in the socket 201. Here, it is noted that the pin 104 can be a captive center pin of the male connector; or, the pin 104 can be the inner conductor (feed through) of the cable (as shown here). In addition, when the port 200 is fully inserted into the receiving area of the male connector 100, the front support member 107 is aligned with the rear ramp 256 when fully inserted, to form an RF seal between the male connector 100 and the female port 200. More specifically, the front support member 107 is configured to be sufficiently close to the rear ramp 256 to provide an RF seal. For example, a gap of zero to 0.2 mm (and in one embodiment, 0.1 mm) can be provided between the inwardly-facing inner surface of the front support member 107 and the outwardly-facing outer surface of the rear ramp 256. In other embodiments, the gap is larger than zero and less than or equal to about 0.2 mm. That gap is sufficiently small to provide a labyrinth seal, whereby RF signals cannot pass. In other embodiments, the front support member 107 can be sufficiently flexible to ride up the sloped lip 257 and onto the top of the ramp 256 so the inwardly-facing inner surface of the front support member 107 RF-sealingly engages with the outwardly-facing outer surface of the rear ramp 256.

The inclination of the forward sloped mating surface 258 controls, to some extent, how easy it is to install the port 200 in the male receiving portion 101. This is referred to here as activation, as this starts the compression of the spring, i.e., the intermediate portion 156 of the displacement member 150. The size of the lip 253 at the rear of the forward ramp 252 and the inclination of the lip 253 controls the retaining function. As the spring, when fully inserted goes to a more relaxed state (not fully relaxed, but less compressed than when it passes the front ramp 252), the spring has to be reactivated to start the removal (sliding back over the lip 253 and the forward ramp 252).

Thus, the lip 253 of the front ramp 252 applies a forward insertion force that applies a forward insertion pressure or force that moves the female interface surface or flange 222 toward the male interface surface or flange 122 with a constant pressure. That ensures that the female interface flange 222 remains in constant and reliable mechanical contact and electrical communication with the male interface flange 122, which can both be made of conductive material (e.g., metal). It also pulls the connector to fully engage if the cable has been pulled slightly but not fully off. For instance, if the male connector 100 or female port 200 are inadvertently pulled in a disengaging direction with insufficient force, the lip 253 and the rear surface (e.g., the rear of the curved spring (FIG. 4A) or the rear angled portion 164 (FIGS. 4G, 5D)) of the displacement member 150 prevent the male connector from separating from the female port 200. It also controls the installation/removal force required to activate the spring.

Referring to FIG. 2, the front diameter of the male connector housing has a leading support 107 that is proximately located to the aft ramp 256 of the port, making the reliable RF tight connection. The displacement member 150 rests against the forward lip 253 of the forward ramp 252 of the port 200, giving a forward momentum 12 of the male connector 100 to engage the interfaces to full contact. The displacement member 150 is kept in constant tension when engaged to enable the constant forward momentum and RF seal. The RF seal parts do not meet. The air seal tolerance is low (on the order of about 1 tenth of a millimeter, though can vary depending on the application), which is enough to stop leakage. The length of the gap is also a part of the seal function.

Thus, the configuration of the displacement member 150 and the female port 200 cooperate to provide a reliable mechanical and electrical connection between the male connector 100 via the displacement member 150, and the port 200.

The body 202 of the port 200 in some examples can be threadless (e.g., smooth) at the outer surface that forms a contour (i.e., shape, size, and relative dimensions). The contour is configured to provide activation force adjustment, retainer, RF seal, and constant activation force on spring. The contour of the female port can vary to complement the contour of the displacement member 150. For example, the female port contour can match the displacement member contour (in the relaxed state) so that the female port contour is inversely identical to the displacement member contour. Or, the female port contour can be different than the displacement member contour (in the relaxed state) but configured to engage the displacement member contour. A single female port contour can be utilized with one or more different displacement member contours, as shown in FIGS. 1, 2. And a single displacement member contour can be utilized with one or more different female port contours.

FIGS. 3B-3F, 3H-3L, 4B-4F, 4H-4L show other non-limiting example embodiments of spring contour 151 designs for the displacement member 150. As shown, the intermediate portion of the displacement member 150 need not be uniformly curved (FIGS. 3A, 4A) or angled (FIG. 3G, 4G), but can have a central flat middle (FIG. 3B), an offset flat section (FIGS. 3H, 4H), reverse bends that are curved (FIGS. 3C-3D, 3I, 3K, 3L, 4C-4D, 4I, 4K, 4L) or sharp bends (FIGS. 3E, 3J, 4E, 4J). In addition, the contour 151 can have stepped sections (FIGS. 3F, 3L, 4F, 4L). Other suitable shapes, sizes and dimensions can be provided within the spirit and scope of the present disclosure.

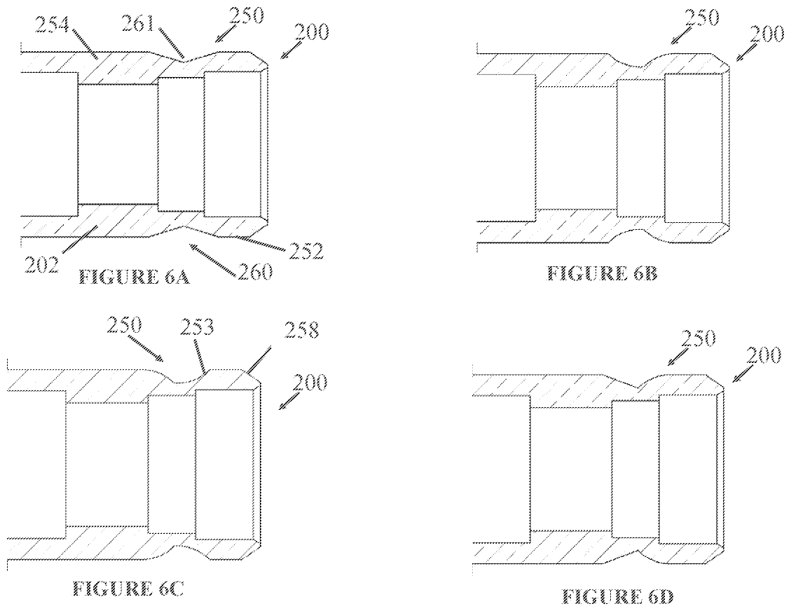

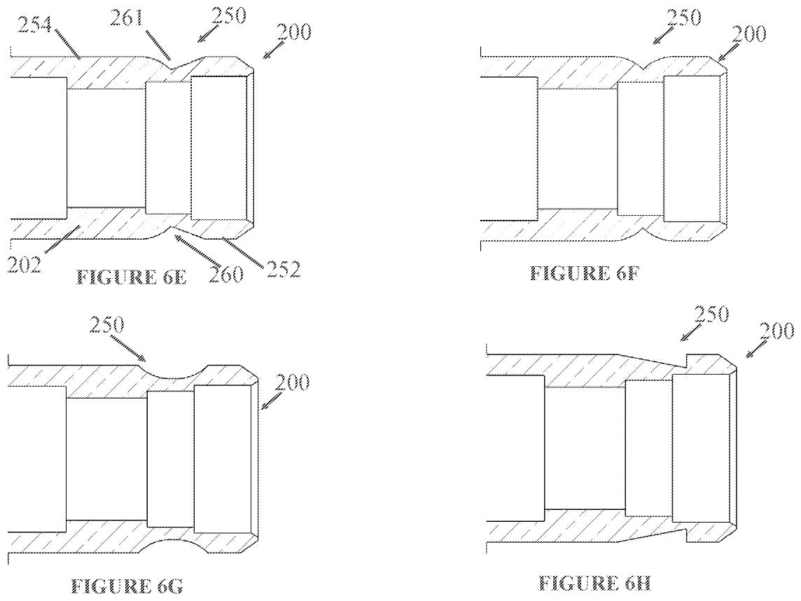

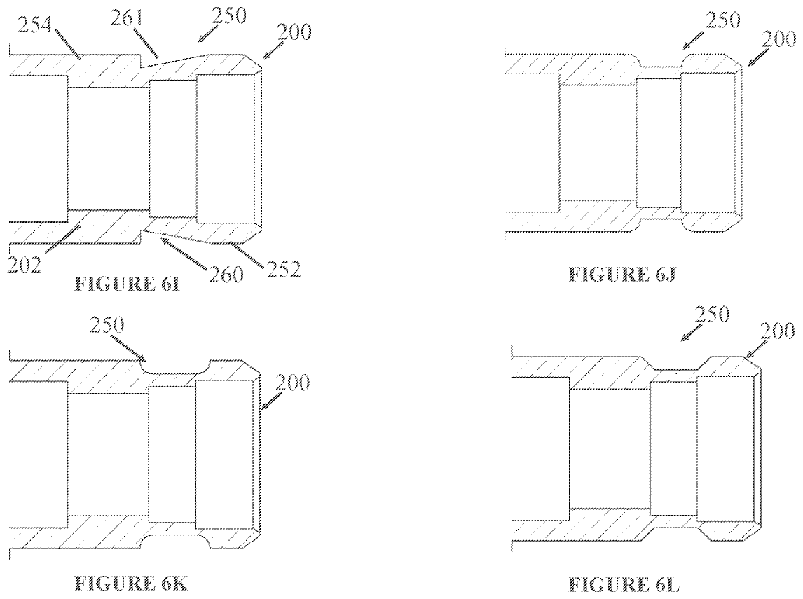

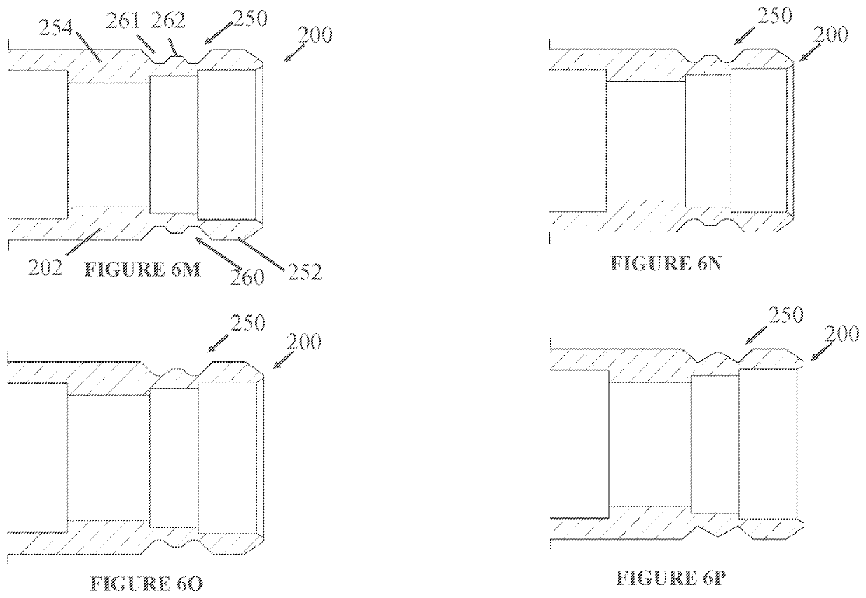

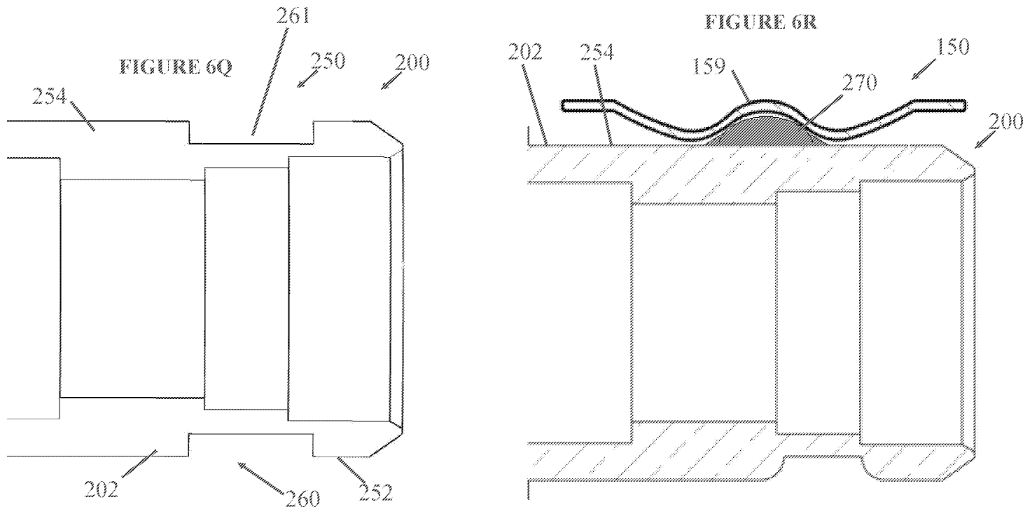

FIGS. 6A-6Q show other non-limiting example embodiments of female contour 250 designs for the body 202 of the female port 200. As illustrated, the outer surface 254 can have a reduced body portion 260, here shown as one or more grooves 261 that is recessed with respect to the outer surface 254 of the body 202 and/or the leading ramp 252, and those grooves can be curved, linear, smooth, or sharply angled. Other suitable shapes, sizes and dimensions can be provided within the spirit and scope of the present disclosure. In the examples shown, the reduced body portion 260 can be provided at the intermediate body portion 208, though in other examples the reduced body portion can be at the rear body portion 204 or the leading body portion 206. The reduced body portion 260 has a reduced body portion diameter that is smaller than the outer surface diameter of the intermediate body portion 208 and/or the outer ramp diameter of the leading ramp 252. The leading ramp diameter of the leading ramp 252 can be the same as the intermediate body diameter of the intermediate body portion 208. As the examples show, the reduced body portion 260 can be directly behind the ramp 252. Here, at least the intermediate portion outer surface 254, the reduced body portion 260 and the leading ramp 252 define an outer contour of the body 202 which engage the displacement member 150 under tension when the male connector is slidably engaged with the mating port 200.

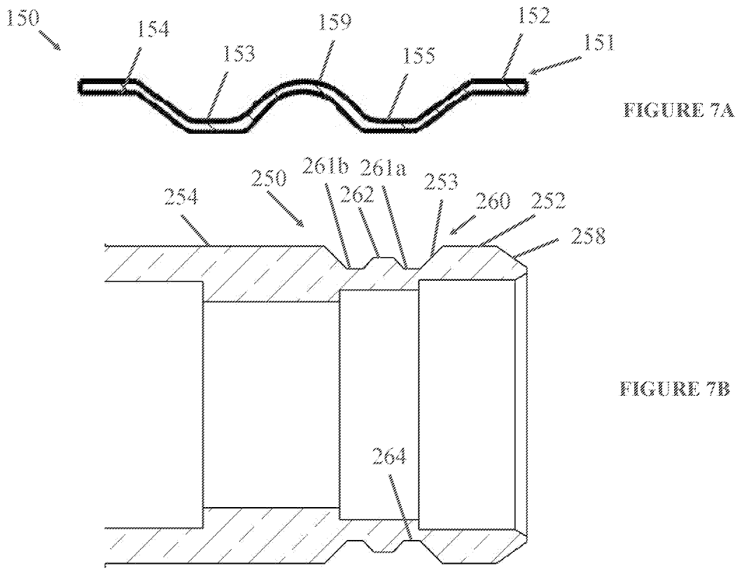

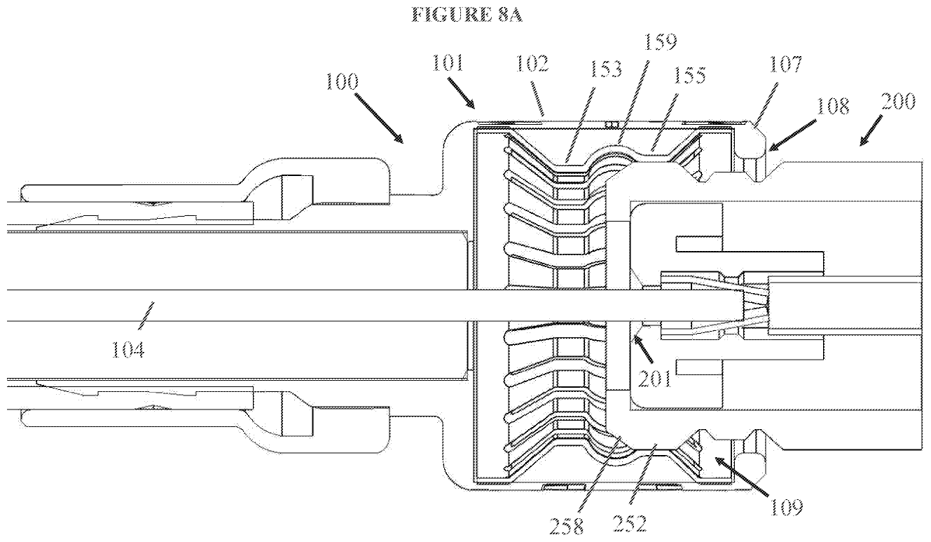

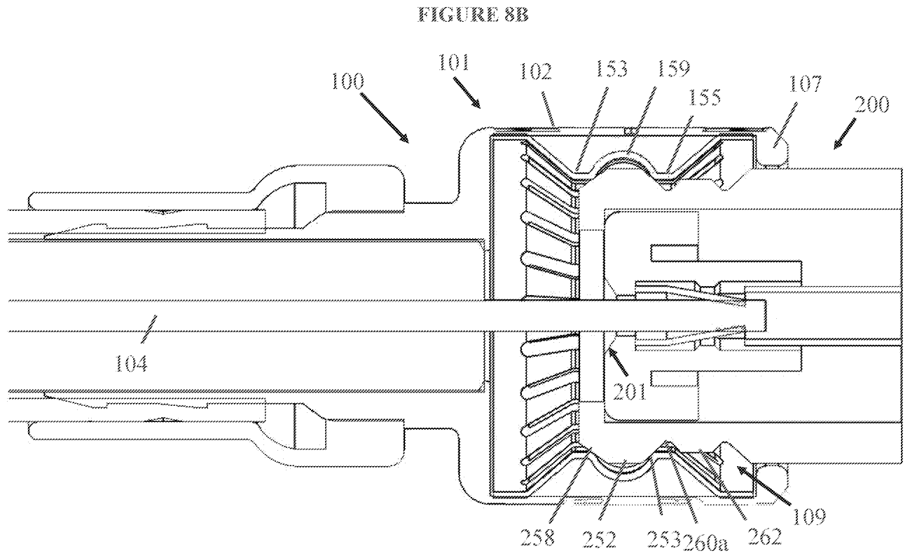

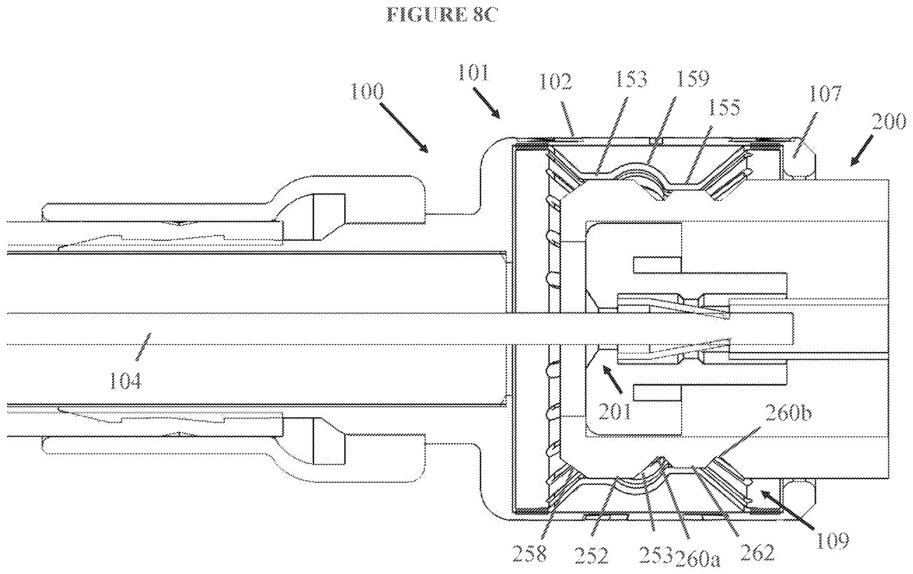

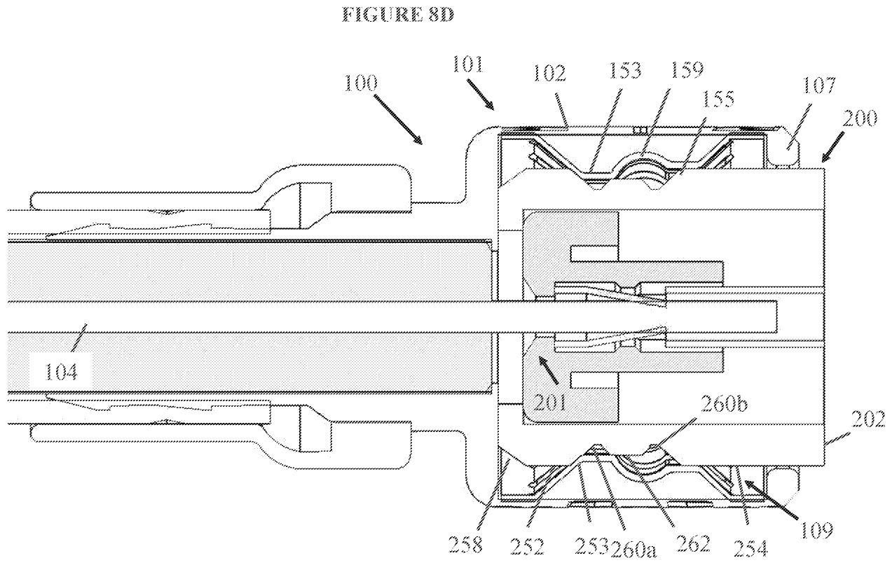

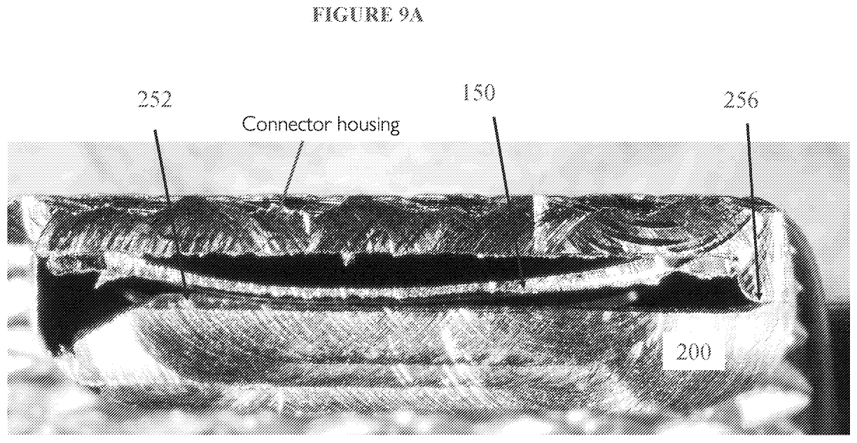

It is noted that in some embodiments, the contour 151 of the displacement member 150 can be matched to a similar female contour 250, such as for example shown in FIGS. 7-8. However, in other embodiments, the displacement member contour 151 need not align with the female contour 250, such that one or more of the displacement contours 151 can be utilized with one or more of the female contours 250. In FIG. 6C, for example, the female contour can have one or more grooves 261, here shown forming the forward ramp 252 having a forward sloped mating surface 258 and a rear lip 253 that can engage with a mating spring displacement member 150.

Turning to FIGS. 7A, 7B, 8A-8D, the female contour 250 shown in FIG. 6M is shown with a mating displacement member 150 having the displacement contour 151 shown in FIGS. 3I, 4I. As best shown in FIG. 7B, a recess or groove 261 is positioned circumferentially about the outer contour surface 250 of the female port body 202 directly behind the leading ramp 252. The groove 261 is recessed in the body 202 with respect to the outer surface 254 of the body, and can have a flat bottom (FIG. 6M) or a curved bottom (FIG. 6N). A center ramp or ledge 262 is provided extending upward from the bottom 264 of the groove 261 to form a leading groove section 261a and a rear groove section 261b. The ledge 262 can have a flat top surface, as shown, that is recessed with respect to the top surface of the ramp 252 and/or the top flat surface 254 of the female body 202. The ramp 252 includes a front sloped surface 258 and a rear sloped surface forming the lip 253. The lip 253 is formed between the top surface of the ramp 252 and the bottom surface 264 of the groove 261.

As also shown in the non-limiting example of FIG. 7A, the displacement member 150 is a spring having a single piece displacement body with a contour 151. The contour 151 has two curved sections 153, 155 connected at opposite ends of a central reverse bend section 159. The contour 151 has a first flat end 152 that leads to the first curved section 153 that leads to the reverse bend 159 that leads to the second curved section 153 that leads to the second flat end 154. That overall configuration forms a general extended sinusoidal shape. The curved sections 153, 155 have a flattened bottom. That is, the curved sections 153, 155 have a flat bottom in the relaxed mode. When under tension, it may bend very slightly to form a concave contour towards the female flat surface.

FIGS. 8A-8D show the port 200 being inserted through the opening 108 of the receiving portion 101 and into the interior receiving area 109 of the receiving portion 101 of the male connector 100. Beginning with FIG. 8A, the port 200 is initially inserted into the receiving portion 101 so that the pin 104 enters the (female) socket 201. In addition, the leading spring curved section 155 has a forward sloped arm that contacts the front sloped surface 258 of the leading ramp 252. The sloped arm and sloped surface 258 compress the leading curved section 155 outwardly toward the side wall 102. As shown, the rear curved section 153 may move slightly outwardly as well, but the rear curved section 153 is positioned further inward than the forward curved section 155, with respect to the side wall 102 and the center longitudinal axis of the connector.

Turning to FIG. 8B, the (female) port 200 is further slidably received in the receiving portion 101 of the male connector 100. At this point, the leading curved section 155 has extended over the top surface of the leading ramp 252. Once the leading curved section 155 extends past the leading ramp 252, it springs outward into the reduced body portion 260 to a less-compressed state, creating a first snapping noise. That audible sound alerts the user that a first insertion point has been reached. The expansion of the spring going over the first step will increase the required force to engage into the second step. So, by controlling the force required for first step (diameter of spring/housing/f-port) you also control the peak force of the second step. Also, at this point, the leading surface of the rear curved section 153 contacts the front sloped surface of the leading ramp 252.

In addition, the curved section 155 and the leading ramp 252 provide a self-engaging (i.e., assisted user installation) feature, whereby the rear of the leading curved section 155 slides down the rear slope of the leading ramp 252. And, the curved section 155 and leading ramp 252 provide a self-retracting feature, whereby if the cable is pulled and then released, it is the same feature/function that re-engage the interfaces. This self-retracting feature maintains RF performance because it ensures that the parts are engaged to provide an RF seal by preventing RF leakage in the higher frequency bands. If the parts were otherwise allowed to move slightly away from each other, the connection would start to leak in the higher frequency bands.

Turning to FIG. 8C, the user continues to insert the port 200 into the receiving area 109 of the receiving portion 101, and the pin 104 is further received in the socket 201. Here, the leading curved section 155 of the displacement member 150, slides along the top surface of the ledge 262 and the rear curved section 153 is outwardly compressed and slides along the top surface of the leading ramp 252. The ledge 262 has a smaller diameter than the leading ramp 252, so that the rear curved section 153 is more compressed than the leading curved section 155.

Finally, at FIG. 8D, the port 200 is fully received in the receiving area 109 of the receiving portion, and the pin 104 is fully received in the socket 201. The leading curved section 155 rides up the sloped leading surface to the outer surface 254 of the body 202. The outer surface 254 of the body 202 has a same diameter as the leading ramp 252. The rear curved section 153 extends past the leading ramp 252. Once the rear curved section 153 extends past the leading ramp 252, it springs outward into the leading groove 261a to a less-compressed state, creating a second snapping noise. That audible sound alerts the user that a final insertion point has been reached. Also, at this point, the rear surface of the rear curved section 153 contacts the rear sloped surface lip 253 of the leading ramp 252. To remove the port 200 from the male connector 100, the user would have to provide sufficient force to move the rear curved section 153 up the rear lip 253 of the leading ramp 252, which prevents the port 200 from being inadvertently removed from the male connector 100, such as from vibrations or accidental user contact. The forward or leading spring curved section 155 is more compressed than the rear curved section 153, so that the leading spring curved section 155 maintains a reliable electrical contact with the outer surface 254 of the body 202 of the port 200. Thus, in the operation or activated mode, at least the leading spring curved section 155 is at least partly compressed.

As further illustrated in FIG. 8D, the front support member 107 can be sufficiently close to the outer surface 254 of the body 202 to provide an RF seal. In other embodiments, an RF ramp 256 can be provided, as in FIGS. 1, 2, 5, and RF ramps 256 can be provided in each of the ports 200 shown in FIGS. 6A-6Q. Adjusting the diameter controls the forces applied. This will also impact the force required to install/activate the spring displacement member 150. The higher compression on the part of the spring will bend the remaining part of the spring in an inwards movement.

The rear curved section 153 controls the retaining forces as well as the removal force required. Adjusting the diameter of the center point in the notch will change the forces. The diameter of the forward ramp 252 controls the installation/removal force, and the ramp lip 253 inclination controls the activation/retaining forces.

The bottom of the curved members 153, 155 each form a contact area, so that the insertion will be in 2 steps. At a first step, the rear curved section 153 is directed by the sloped surface 258 and along the top surface of the ramp 252 and into the groove 261 where it comes into contact with the top surface of the center ledge 262. Less installation force is needed, but still provides an audible snap by the contact area of the rear curved section 153 striking the ledge 262.

At a second step, the rear curved section 153 slides along the top surface of the body 202 and the forward curved section 155 slides along the forward ramp 252 until it enters the groove 261 and strikes the top surface of the center ledge 262, providing a second audible snap. This configuration also provides an extra security if the cable is pulled unintendedly as the second spring will reach the retaining function and holding the connector not fully engaged but still engaged enough for a signal to pass.

The embodiments shown in FIGS. 3, 4, 6 enable one or more audible snaps to indicate the insertion status of the male connector and female or mating port. Those embodiments also have an operational state in which the male connector and port are fully engaged, and the displacement member is at least partly compressed to provide a reliable connection. And, an RF seal is provided by having the support member 107 sufficiently close to the outer surface of the body, such as at a ramp 256 of the body 202. In some embodiments, the front ramp can be left out, though the removal force would not be controllable and the self-engaging feature not provided.

Another non-limiting illustrative embodiment of the disclosure is shown, for example, in FIG. 6R. Here, the port 200 has a body 202 with a smooth, threadless outer surface 254. An annular shoulder, such as a lump or hump 270 is provided that projects outward from the outer surface 254. The hump 270 can be smooth and curved, as shown, or can be linear and angled. The hump 270 can have a mirrored geometry with respect to the displacement member 150, e.g., a curved cross-section that is sized and shaped to conform to the displacement member 150, and particularly to the reverse bend 159 of the displacement member 150. Though one hump 270 is shown, more than one hump can be utilized. And, notably no groove is provided in the body 202, though in other embodiments the body 202 can have one or more grooves and one or more humps 270. In addition, further features can be utilized, other than grooves or humps, within the spirit and scope of the present disclosure.

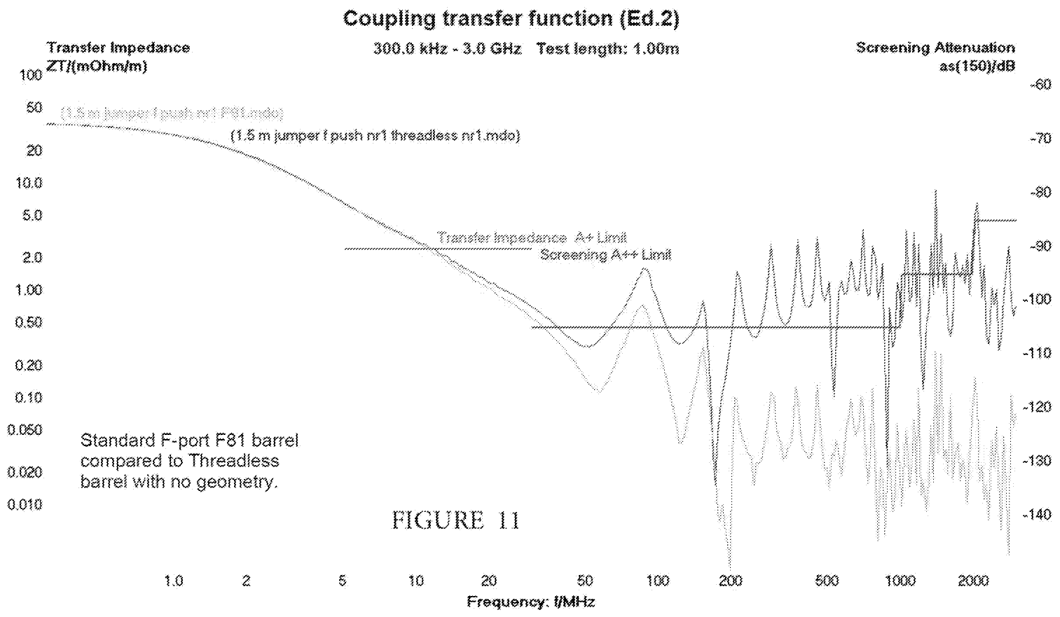

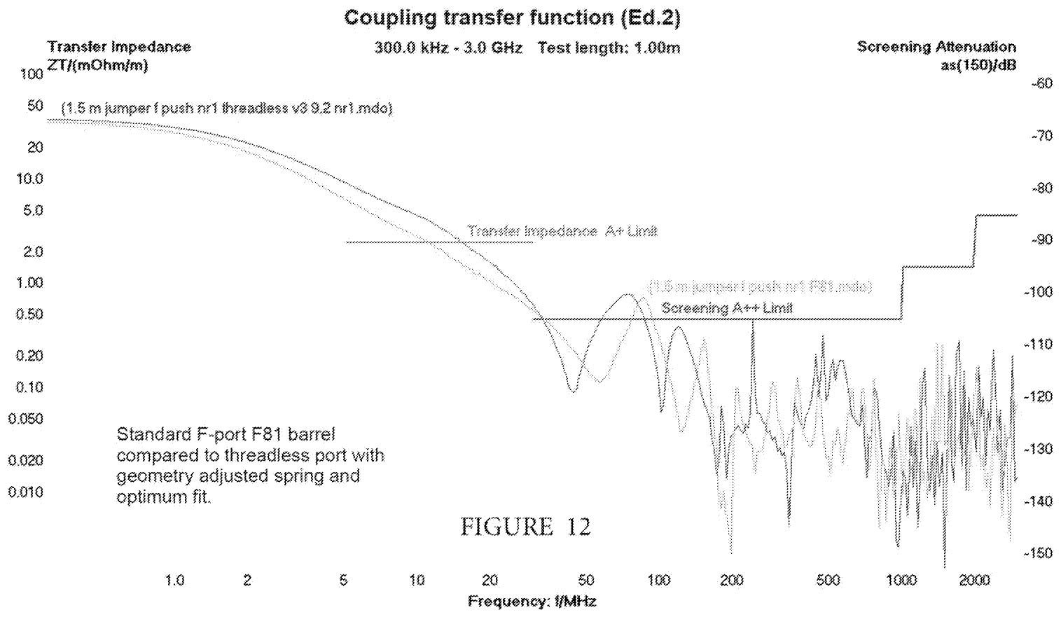

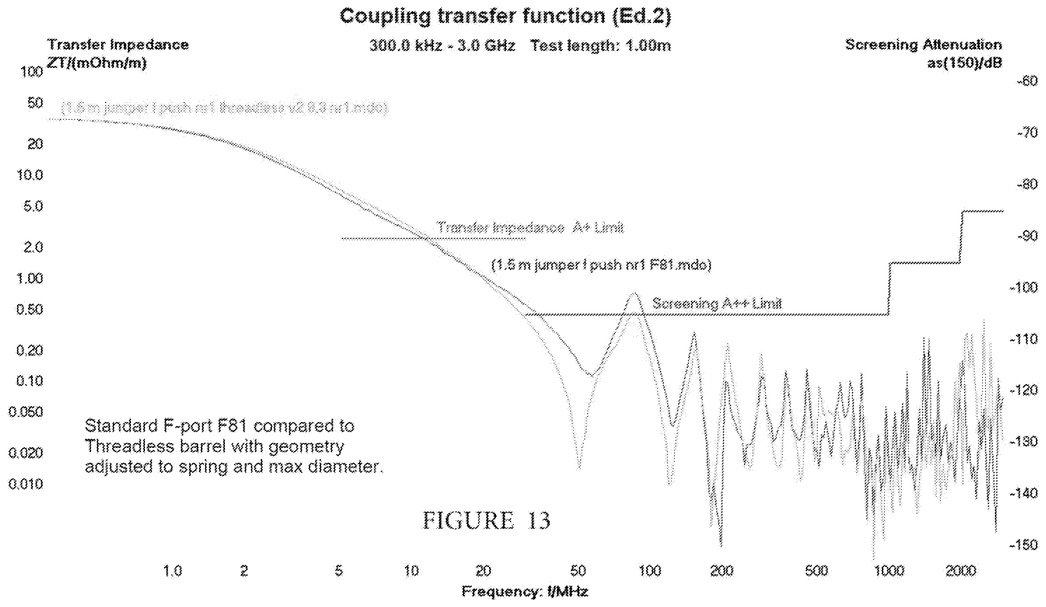

FIGS. 11-13 show the RF leakage as a function of the pressures. These figures illustrate the screening performance of a straight non-threaded port, a mating or female port with the geometry as in FIGS. 1, 2 and 4 in two variations: one with a diameter of the flat intermediate portion 254 of 9.2 mm and the ramp 252 0.2 larger in radius, and the second being 9.3 mm and the ramp 0.2 mm larger. The RF seal on both has the same diameter. This is to show what impact the tension of the spring (both towards the female body but also in the retainer function) has on the electrical performance. When the port is inserted, the spring is deflected towards the outer diameter of the male connector housing. It flexes in this position until the final state has been reached where it settles in a non-relaxed mode given by the geometry of the port's contour.

The use of adjustable geometry to fit the spring (not in relaxed state but displaced to fit) allow for low loss in transfer impedance and high frequency screening which is hard to obtain on a normal basis with spring loaded connectors. The geometry may also allow the use of 2 or more different spring designs with only one port geometry.

It is further noted that in some embodiments the port can be made with threads to accommodate the use of both normal F-type connectors and push-on connectors. An F-port with damaged threads can be reworked to simply contour for a push-on connector to fit.

In some embodiments, the displacement member 150 is made of a single piece metal sheet. The flexibility is made with elongated holes in the spring, gills. These gills also act as small antennas. When installed on a female or mating port, most of the antenna function is removed, but not fully. If two identical springs are used in the same housing, the gills will overlap as the inner spring has a slightly smaller diameter thus closing all the gills and removing the antenna function of the spring.

Accordingly, the connector 10, such as the F-type connector in one example, provides an F-type female port 200 having an outer surface and contour that is completely threadless, and an F-type male or coaxial connector 100 that is configured to reliably engage and electrically connect with the F-type female port 200. A spring mechanism, displacement member 150, provides one or more audible snapping noises that indicate to the user whether the female port 200 is partly and/or fully engaged with the male connector 100. The threadless design enables simple push-on installation. In some embodiments, the design can also be used with threaded ports, whereby the spring-loaded connectors also fit normal threaded ports.

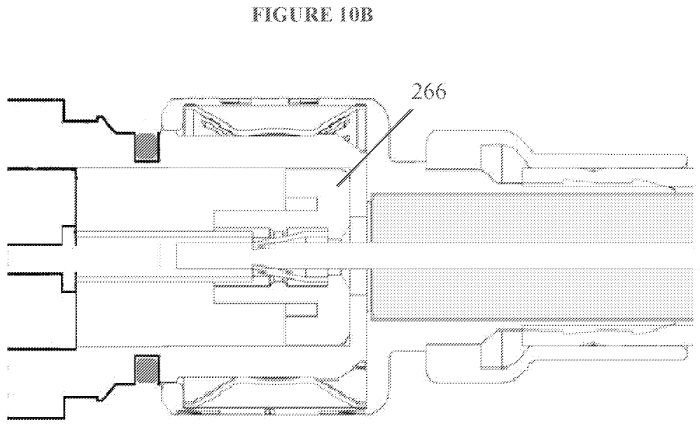

Turning to FIG. 10A, an alignment feature is shown. The alignment feature includes a notch or groove 280 and a colored plastic ring 282. The groove 280 can be located, for example, at the rear RF ramp 256. The groove 280 extends partially into the female port body 202, circumferentially about the body 202. The colored plastic ring 282 is placed into the groove 280 and is retained in the groove 280. This should be straight with the end of the connector to get the proper alignment/installation depth/visual indication? The ring 282 indicates proper alignment, for example the color-ring is only just visible when installed properly, as shown for example in FIG. 10B.

It is further noted that the port body 202, the end-cap 159, and the displacement member 150 are made of metal (brass and phosphor-bronze. The inner conductor 104 can be held in place by plastic isolators 266.

It is noted that the disclosure is directed to a coaxial connector, such as F-type connectors, F-type male connectors, and F-type female ports. It will be apparent, however, that the disclosure can be applied to different applications, such as to other connectors and ports that are not F-type, dudio connections, low-power electrical connectors, and small diameter coaxial connections.

It will be apparent to those skilled in the art having the benefit of the teachings presented in the foregoing descriptions and the associated drawings that modifications, combinations, sub-combinations, and variations can be made without departing from the spirit or scope of this disclosure. Likewise, the various examples described may be used individually or in combination with other examples. Those skilled in the art will appreciate various combinations of examples not specifically described or illustrated herein that are still within the scope of this disclosure. In this respect, it is to be understood that the disclosure is not limited to the specific examples set forth and the examples of the disclosure are intended to be illustrative, not limiting.

It is noted that the drawings may illustrate, and the description and claims may use geometric or relational terms, such as leading, rear, curved, circular, linear, etc. These terms are not intended to limit the disclosure and, in general, are used for convenience to facilitate the description based on the examples shown in the figures. In addition, the geometric or relational terms may not be exact. For instance, walls may not be exactly perpendicular or parallel to one another because of, for example, roughness of surfaces, tolerances allowed in manufacturing, etc., but may still be considered to be perpendicular or parallel.

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” are defined as meaning “no embodiment, or one embodiment, or more than one embodiment, or all embodiments.”

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility, and non-obviousness.

1. A mating port comprising:
a threadless body having a leading body portion, a rear body portion, and an intermediate body portion between the leading body portion and the rear body portion, said intermediate body portion having an outer surface with an outer surface diameter;
a reduced body portion at the intermediate body portion of said body, said reduced body portion having a reduced body portion diameter smaller than the outer surface diameter of said intermediate body portion; and
a leading ramp at the leading body portion of said body, said leading ramp projecting outward with respect to the reduced body portion at said intermediate body portion to define a leading ramp diameter larger than the reduced body portion diameter,
wherein said leading ramp, said outer surface of said intermediate body portion, and said reduced body portion define an outer contour of said threadless body, the outer contour configured to engage a displacement member under tension of a mating connector.

2. The mating port of claim 1, wherein said mating port comprises a female port.

3. The mating port of claim 1, wherein said mating port comprises an F-type port.

4. The mating port of claim 1, said reduced body portion comprising one or more annular grooves positioned in the outer surface of said intermediate body portion directly behind said leading ramp.

5. The mating port of claim 1, wherein the outer contour of said threadless body has a shape that cooperates with the displacement member as the mating connector is slidably engaged with said mating port.

6. The mating port of claim 1, said threadless body having a leading interface surface, whereby said leading ramp cooperates with the displacement member to apply a forward insertion pressure that engages the leading interface surface with a mating interface surface of a male connector.

7. The mating port of claim 1, further comprising a rear ramp at the rear body portion of said body, said rear ramp projecting outward with respect to the outer surface of said intermediate body portion.

8. The mating port of claim 7, wherein said rear ramp cooperates with the displacement member to apply a pressure that provides a radio frequency seal between said female port and the mating male connector.

9. The mating port of claim 7, wherein said rear ramp aligns with a front support member of the mating connector.

10. The mating port of claim 9, further comprising a gap between the rear ramp and the front support member.

11. The mating port of claim 1, wherein the displacement member is a spring.

12. The mating port of claim 1, further comprising an angled surface at a trailing side of said leading ramp, the angled surface configured to engage the displacement member under tension.

13. A mating port comprising:
a threadless body having a leading body portion, a rear body portion, and an intermediate body portion between the leading body portion and the rear body portion, said intermediate body portion having an outer surface with an outer surface diameter; and
a leading ramp at the leading body portion of said body, said leading ramp projecting outward with respect to the intermediate body portion to define a leading ramp diameter larger than the outer surface diameter,
wherein said leading ramp and said outer surface of said intermediate body portion define an outer contour of said threadless body, the outer contour configured to engage a displacement member under tension of a mating connector.

14. A mating port comprising:
a threadless body having an outer contour, said body having a leading body portion, a rear body portion, and an intermediate body portion between the leading body portion and the rear body portion, said intermediate body portion having an outer surface, said threadless body further having a reduced portion with a reduced portion diameter; and
an annular rear ramp at the rear portion of said body, said rear ramp projecting outward with respect to the outer surface of said intermediate body portion and configured to engage a displacement member under tension of a mating male connector.

15. The mating port of claim 14, wherein the outer contour of said threadless body is smooth.

16. The mating port of claim 14 or 15, further comprising a leading ramp at the leading body portion of said body, said leading ramp projecting outward with respect to the outer surface of said intermediate body portion and configured to engage the displacement member under tension of the mating male connector.

17. The mating port of claim 16, said threadless body having a leading interface surface, whereby said leading ramp cooperates with the displacement member to apply a forward insertion pressure that engages the leading interface surface with a mating interface surface of a male connector.

18. The mating port of claim 16, further comprising one or more grooves positioned in the outer surface of said intermediate body portion directly behind the leading ramp.

19. The mating port of claim 16, further comprising an angled surface at a trailing side of said leading ramp, the angled surface configured to engage the displacement member under tension.

20. The mating port of claim 14, wherein said rear ramp cooperates with the displacement member to apply a pressure that provides a radio frequency seal between said female port and the mating male connector.

21. The mating port of claim 14, wherein the displacement member is a spring.

22. A method for engaging a mating port having a threadless body with a leading body portion and an intermediate body portion, and a displacement member of a male connector, the method comprising:
providing the mating port with an annular leading ramp at the leading body portion projecting outward from the intermediate body portion;
providing one or more grooves at the intermediate body portion, wherein the leading ramp and the one or more grooves define an outer contour of the threadless body; and
engaging the outer contour of the threadless body with the displacement member under tension.

23. A mating port comprising:
a threadless body having an outer contour, said body having a leading body portion, a rear body portion, and an intermediate body portion between the leading body portion and the rear body portion, said intermediate body portion having an outer surface; and
an annular outer shoulder and/or annular groove at the intermediate body portion of said body, said annular outer shoulder projecting outward with respect to the outer surface of said intermediate body portion and said groove recessed with respect to the outer surface of said intermediate body portion, said outer shoulder and/or groove configured to engage a displacement member under tension of a mating male connector.
